(19) United States
(12) Patent Application Publication
(10) Pub. No.: US 2020/0349963 A1
(43) Pub. Date: Nov. 5, 2020

(54) ECHO CANCELLATION SYSTEM AND METHOD OF MULTICHANNEL SOUND MIXING

(71) Applicant: AMLOGIC (SHANGHAI) CO., LTD., Shanghai (CN)

(72) Inventors: Renjun Xu, Shanghai (CN); Xiaoqun Chen, Shanghai (CN); Peipeng Zhao, Shanghai (CN)

(73) Assignee: AMLOGIC (SHANGHAI) CO., LTD.

(21) Appl. No.: 16/832,188

(22) Filed: Mar. 27, 2020

(30) Foreign Application Priority Data
Apr. 30, 2019 (CN) 201910363615.3

(51) Int. Cl. G10L 21/0208; G10L 19/008

(52) U.S. Cl. CPC G10L 21/0208; G10L 2021/02082; G10L 19/008

(57) ABSTRACT

The invention provides an echo cancellation system and method of a multichannel sound mixing. The echo cancellation system comprises a voice assistant module and at least one signal generating device for respectively outputting first audio data and second audio data adapted to the configuration of a loudspeaker; a copying module for copying the first audio data and the second audio data to obtain corresponding third audio data and fourth audio data; a first sound mixing module for mixing and converting the first audio data and the second audio data to obtain two-channel first sound mixing data; a second sound mixing module for mixing the third audio data and the fourth audio data to obtain second sound mixing data; an echo cancellation module for echo cancellation according to the first sound mixing data; and a playing module for receiving and playing the second sound mixing data.

### CROSS-REFERENCE TO RELATED APPLICATIONS

The present application claims priority to and the benefit of Chinese Patent Application No. CN 201910363615.3 filed on Apr. 30, 2019, the entire content of which is incorporated herein by reference.

### BACKGROUND OF THE INVENTION

### 1. Field of the Invention

The invention relates to the field of echo cancellation, and more particularly, to an echo cancellation system and method of a multichannel sound mixing.

### 2. Description of the Related Art

In the prior art, acoustic echo is a major problem for audio devices. For conventional voice assistants, audio channel output and echo sampling are always carried out in a two channel signal. Also, the configuration of loudspeaker of the audio device only supports the output from the two channel signal.

Therefore, the conventional voice assistants having voice interaction capabilities are typically two-channel device and mono-channel device, that is, the audio output of the voice assistant only supports the output of its own audio. Therefore, in order to eliminate external noise and self-excitation echo and other noise, the voice assistant usually re-acquires the sound of the two channel or the mono channel having been played, and the noise is filtered out by using an algorithm related to Acoustic Echo Cancellor (AEC); thus, the conventional echo cancellation system does not allow for the output of the mixed audio after the sound mixing of the multichannel audio data.

In the prior art, the output of the multichannel audio is mutually exclusive with its own single audio output. That is, when the multichannel audio is playing, its own single audio output is disabled, or, when its own single audio output is playing, the multichannel audio is disabled. Therefore, in the prior art, the multichannel audio and its own single audio may be output at the same time. However, only the sound of the two channel or the mono channel of its own single audio is re-acquired. When the voice assistant outputs a two-channel data, the output audio data is used for echo cancellation before outputting to a mixer. In this way, only the echo output from the voice assistant can be suppressed, however, echo cancellation cannot be achieved through the output of an application or an audio decoder, and thus, only the two-channel sound can be re-acquired. Therefore, the prior art is not capable of re-acquiring the multichannel audio data, so that echo cancellation cannot be achieved effectively, and the functional diversity and the quality of products are decreased.

### SUMMARY OF THE INVENTION

Given that the foregoing problems exist in the prior art, the present invention provides an echo cancellation system of a multichannel sound mixing, in which echo cancellation is achieved according to mixed sound mixing data of the multichannel audio data.

The technical solution is as follows:

An echo cancellation system of a multichannel sound mixing, comprising:

a voice assistant module for outputting first audio data adapted to the configuration of a loudspeaker;

at least one sound signal generating device for outputting second audio data adapted to the configuration of the loudspeaker;

a copying module, connected to the voice assistant module and the at least one sound signal generating device, respectively, configured to receive the first audio data and the second audio data, and configured to copy the first audio data and the second audio data to obtain third audio data corresponding to the first audio data and fourth audio data corresponding to the second audio data;

a first sound mixing module, connected to the copy module, configured to receive the first audio data and the second audio data, and configured to mix and convert the first audio data and the second audio data to obtain two-channel first sound mixing data;

a second sound mixing module, connected to the copy module, configured to receive the third audio data and the fourth audio data, and configured to mix the third audio data and the fourth audio data to obtain second sound mixing data;

an echo cancellation module, connected to the first sound mixing module, and configured to perform echo cancellation according to the first sound mixing data; and

a playing module, connected to the second sound mixing module, and configured to receive and play the second sound mixing data.

Preferably, in the echo cancellation system, wherein the sound signal generating device comprises an application and/or an audio decoder.

Preferably, the echo cancellation system further comprises:

a reference module, connected to the first sound mixing module and echo cancellation module, respectively, configured to generate reference data corresponding to the first sound mixing data, and configured to input the first sound mixing data and the reference data to the echo cancellation module.

Preferably, in the echo cancellation system, wherein the reference data is timestamp information corresponding to the first sound mixing data.

Preferably, in the echo cancellation system, wherein the configuration of the loudspeaker comprises a 2.0 channel loudspeaker, a 5.1 channel loudspeaker, and a 7.1 channel loudspeaker.

Preferably, in the echo cancellation system, wherein the playing module converts and amplifies the second sound mixing data through a driver, and output the converted and amplified data to a corresponding loudspeaker.

Preferably, in the echo cancellation system, wherein the echo cancellation to module comprises:

a sound acquisition unit for acquiring live audio data;

an echo cancellation unit, connected to the sound acquisition unit, configured to perform echo cancellation on the live audio data according to the first sound mixing data, and configured to sent the sound mixing data subjected to is the echo cancellation to the voice assistant module.

An echo cancellation method of a multichannel sound mixing is also provided, the method comprising the steps of:

Step S1, receiving first audio data, output from a voice assistant module, and adapted to the configuration of a loudspeaker, and receiving second audio data, output from at least one sound signal generating device, and adapted to the configuration of the loudspeaker;

Step S2, copying the first audio data and the second audio data to obtain third audio data corresponding to the first audio data and fourth audio data corresponding to the second audio data;

Step S3, receiving the first audio data and the second audio data, and mixing and converting the first audio data and the second audio data to obtain two-channel first sound mixing data; and receiving the third audio data and the fourth audio data, and mixing the third audio data and the fourth audio data to obtain second sound mixing data;

Step S4, performing echo cancellation according to the first sound mixing data; and receiving and playing the second sound mixing data.

Preferably, the echo cancellation system further comprises a step between Step S3 and Step S4: generating reference data corresponding to the first sound mixing data, and inputting the first sound mixing data and the reference data to the echo cancellation module.

By adopting the above-mentioned technical solutions, the present invention has the beneficial effects that mixed sound mixing data of the multichannel audio data is effectively obtained, and echo cancellation is achieved according to the obtained mixed sound mixing data, and thus the functional diversity and the quality of products are improved.

### BRIEF DESCRIPTION OF THE DRAWINGS

The accompanying drawings, together with the specification, illustrate exemplary embodiments of the present disclosure, and, together with the description, serve to explain the principles of the present invention.

FIG. 1 is a function block diagram of an echo cancellation system according to an embodiment of the present invention;

FIG. 2 is a functional block diagram of an echo cancellation module of the echo cancellation system according to an embodiment of the present invention; and

FIG. 3 is a flowchart of an echo cancellation method according to an embodiment of the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of is stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

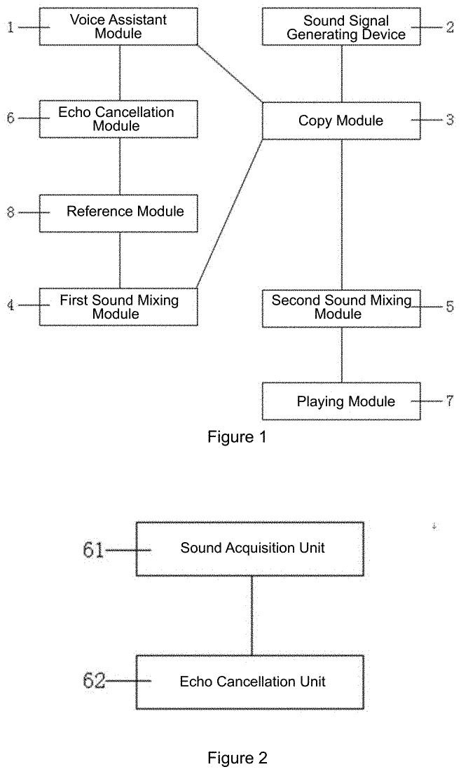

As shown in FIG. 1, the invention comprises an echo cancellation system of a multichannel sound mixing, comprising:

a voice assistant module 1 for outputting first audio data adapted to the configuration of a loudspeaker;

at least one sound signal generating device 2 for outputting second audio data adapted to the configuration of the loudspeaker;

a copying module 3, connected to the voice assistant module 1 and at least one sound signal generating device 2, respectively, configured to receive the first audio data and the second audio data, and configured to copy the first audio data and the second audio data to obtain third audio data corresponding to the first audio data and fourth audio data corresponding to the second audio data;

a first sound mixing module 4, connected to the copy module 3, configured to receive the first audio data and the second audio data, and configured to mix and convert the first audio data and the second audio data to obtain two-channel first sound mixing data;

a second sound mixing module 5, connected to the copy module 3, configured to receive the third audio data and the fourth audio data, and configured to mix the third audio data and the fourth audio data to obtain second sound mixing data;

an echo cancellation module 6, connected to the first sound mixing module 4, and configured to perform echo cancellation according to the first sound mixing data; and

a playing module 7, connected to the second sound mixing module 5, and configured to receive and play the second sound mixing data.

In the above-mentioned embodiment, the voice assistant module 1 and the at least one sound signal generating device 2 correspondingly output the first audio data and the second audio data adapted to the configuration of the loudspeaker. The copy module 3 copies the first audio data and the second audio data to obtain the third audio data corresponding to the first audio data and the fourth audio data corresponding to the second audio data. The first sound mixing module 4 mixes and converts the first audio data and the second audio data to obtain the two-channel first sound mixing data. The echo cancellation module 6 performs, according to the first sound mixing data, echo cancellation on the live audio data received by the echo cancellation module 6. The playing module 7 plays the second sound mixing data obtained by the sound mixing of the third audio data and the fourth audio data through the second sound mixing module 5. Therefore, mixed sound mixing data of the multichannel audio data is effectively obtained, and echo cancellation is achieved by the obtained mixed sound mixing data, and thus the functional diversity and the quality of products are improved.

The echo cancellation module 6 adopts the first sound mixing data as a reference when performing echo cancellation. The first sound mixing data comprises both the first audio data and the second audio data. Therefore, the echo cancellation module 6 not only uses the first audio data output from the voice assistant 1 as the reference, but also uses the second audio data output from other sound signal generating devices 2 as the reference, so that the accuracy of the echo cancellation is improved and the external noise is greatly suppressed.

Furthermore, in the above-mentioned embodiment, the sound signal generating device 2 comprises an application and/or an audio decoder.

Typically, the echo cancellation system processes second audio data in the application and the audio decoder.

Furthermore, in the above-mentioned embodiment, the echo cancellation system further comprises a reference module 8, connected to the first sound mixing module 4 and echo cancellation module 6, respectively, configured to generate reference data corresponding to the first sound mixing data, and configured to input the first sound mixing data and the reference data to the echo cancellation module 6. As a result, the echo cancellation module 6 performs echo cancellation according to the first sound mixing data and the reference data.

Furthermore, in the above-mentioned embodiment, the reference data is timestamp information corresponding to the first sound mixing data for providing time reference.

The reference module 8 comprises a virtual sound card equipment. The reference module 8 may provide the echo cancellation module 6 with accurate timestamp information to be corresponding to the first sound mixing data. The timestamp information is used to provide time reference when the echo cancellation module 6 performs echo cancellation according to the first sound mixing data, so that the accuracy of the echo cancellation is improved.

Furthermore, in the above-mentioned embodiment, the configuration of the loudspeaker comprises a 2.0 channel loudspeaker, a 5.1 channel loudspeaker, and a 7.1 channel loudspeaker, that is, the loudspeaker can output and receive two-channel, six-channel and eight-channel audio data.

Furthermore, in the above-mentioned embodiment, the playing module 7 converts and amplifies the second sound mixing data through a driver, and output the converted and amplified data to a corresponding loudspeaker. Therefore, it is possible to play the mixed sound mixing data of the multichannel audio data.

Furthermore, in the above-mentioned embodiment, as shown in FIG. 2, the echo cancellation module 6 comprises:

a sound acquisition unit 61 for acquiring live audio data;

an echo cancellation unit 62, connected to the sound acquisition unit 61, configured to perform echo cancellation on the live audio data according to the first sound mixing data, and configured to sent the sound mixing data subjected to the echo cancellation to the voice assistant module.

The live audio data is all the audio data acquired by the sound acquisition unit 61, that is, the live audio data comprises the first sound mixing data.

Furthermore, as a preferred embodiment, the loudspeaker is configured to be a two-channel loudspeaker. The echo cancellation system is applied to Linux Alsa system. The copy module 3 here maybe an Alsa Multi Plug-in. The Alsa Multi Plug-in copies two-channel audio data of all the audio playing sources to the first sound mixing module 4 and the second sound mixing module 5 for sound mixing, so as to obtain corresponding first sound mixing data and second sound mixing data. The first sound mixing module 4 sends the first sound mixing data to the echo cancellation module 6 through the reference module 8, and the echo cancellation module 6 performs echo cancellation on the first sound mixing data. The second sound mixing module 5 sends the second sound mixing data to the playing module 7. The playing module 7 converts and amplifies the second sound mixing data through a driver, and output the converted and amplified data to a corresponding loudspeaker, so that playing of the second sound mixing data is achieved.

When the playing sources comprise an audio decoder outputting the multichannel audio, the audio decoder is required to covert the multichannel audio data into the two-channel/mono-channel second audio data. For example, the audio decoder may convert the six-channel audio data into two-channel second audio data for outputting by using the following codes (1)

```
pcm.loopback {
  type route
  slave.pcm “hw:1,1,0” #input loudspeaker nodes
  slave.channels 6 #input the number of sound channels
  ttable.0.0 0.3 # channel mapping and channel ratio, 0.3 represents
```

30% of mapping percentage

| ttable.1.1 0.3 | |
|---|---|
| ttable.0.2 0.3 | |
| ttable.1.3 0.3 | |
| ttable.0.4 0.3 | |
| ttable.1.5 0.3 | |
| } | ( 1 ) |

Similarly, the audio decoder may convert the eight-channel audio data into two-channel second audio data for outputting.

Furthermore, as a preferred embodiment, the loudspeaker is configured to be a six-channel loudspeaker. The echo cancellation system is applied to Linux Alsa system. The copy module 3 here maybe an Alsa Multi Plug-in.

The Alsa Multi Plug-in outputs the multichannel audio data of all the playing sources to the first sound mixing module 4 for sound mixing, to obtain the two-channel first sound mixing data, and the Alsa Multi Plug-in outputs the multichannel audio data of all the playing sources to the second sound mixing module 5 for sound mixing, to obtain second sound mixing data. The first sound mixing module 4 sends the first sound mixing data to the echo cancellation module 6 through the reference module 8, and the echo cancellation module 6 performs echo cancellation on the first sound mixing data. The second sound mixing module 5 sends the second sound mixing data to the playing module 7. The playing module 7 converts and amplifies the second sound mixing data through a driver, and output the converted and amplified data to a corresponding loudspeaker, so that playing of the second sound mixing data is achieved.

Wherein, the Alsa Multi plug-in may convert the six-channel audio data into two-channel first sound mixing data for output through the program (1).

Similarly, the Alsa Multi plug-in may convert the eight-channel audio data into the two-channel first sound mixing data for output.

Wherein, when the playing source comprises the application of the two-channel audio, the application needs to convert the two-channel audio data into the six-channel second audio data for output. When the playing source comprises the voice assistant 1 of the two-channel audio, the voice assistant 1 needs to convert the two-channel audio data into the six-channel second audio data for output. For example, both the application and the voice assistant 1 may convert the two-channel audio data into the six-channel second audio data for output through the following codes (2).

| pcm.output { | |
|---|---|
| type route | |
| slave.pcm “outsideinput” #output next level of devices | |
| slave.channels 6 | |
| ttable.0.0 1 | |
| ttable.1.1 1 | |
| ttable.0.2 1 | |
| ttable.1.3 1 | |
| ttable.0.4 1 | |
| ttable.1.5 1 | |
| } | ( 2 ) |

Similarly, both the application and the voice assistant 1 may convert the two-channel audio data into the eight-channel second audio data for output.

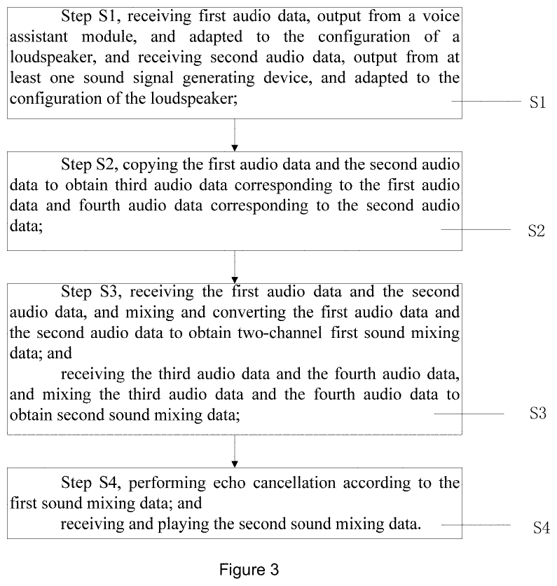

An echo cancellation method of a multichannel sound mixing is also provided, as shown in FIG. 3, the method comprising the steps of:

Step S1, receiving first audio data, output from a voice assistant module 1, and adapted to the configuration of a loudspeaker, and receiving second audio data, output from at least one sound signal generating device 2, and adapted to the configuration of the loudspeaker;

Step S2, copying the first audio data and the second audio data respectively to obtain third audio data corresponding to the first audio data and fourth audio data corresponding to the second audio data;

Step S3, receiving the first audio data and the second audio data, and mixing and converting the first audio data and the second audio data to obtain two-channel first sound mixing data; and

receiving the third audio data and the fourth audio data, and mixing the third audio data and the fourth audio data to obtain second sound mixing data;

Step S4, performing echo cancellation according to the first sound mixing data; and

receiving and playing the second sound mixing data.

By adopting the above-mentioned method, mixed sound mixing data of the multichannel audio data is effectively obtained, and echo cancellation is achieved according to the obtained mixed sound mixing data, and thus the functional diversity and the quality of products are improved.

Furthermore, in the above-mentioned embodiment, the method further comprises a step between Step S3 and Step S3: generating reference data corresponding to the first sound mixing data, and inputting the first sound mixing data and the reference data to the echo cancellation module 6.

The reference data is timestamp information corresponding to the first sound mixing data. The timestamp information is used to provide time reference when the echo cancellation module 6 performs echo cancellation on the first sound mixing data, so that the accuracy of the echo cancellation is improved.

The above descriptions are only the preferred embodiments of the invention, not thus limiting the embodiments and scope of the invention. Those skilled in the art should be able to realize that the schemes obtained from the content of specification and drawings of the invention are within the scope of the invention.

What is claimed is:

1. An echo cancellation system for a multichannel sound mixing, comprising:
a voice assistant module for outputting first audio data adapted to the configuration of a loudspeaker;
at least one sound signal generating device for outputting second audio data adapted to the configuration of the loudspeaker;
a copying module, connected to the voice assistant module and the at least one sound signal generating device, respectively, configured to receive the first audio data and the second audio data, and configured to copy the first audio data and the second audio data to obtain third audio data corresponding to the first audio data and fourth audio data corresponding to the second audio data;
a first sound mixing module, connected to the copy module, configured to receive the first audio data and the second audio data, and configured to mix and convert the first audio data and the second audio data to obtain two-channel first sound mixing data;
a second sound mixing module, connected to the copy module, configured to receive the third audio data and the fourth audio data, and configured to mix the third audio data and the fourth audio data to obtain second sound mixing data;
an echo cancellation module, connected to the first sound mixing module, and configured to perform echo cancellation according to the first sound mixing data; and
a playing module, connected to the second sound mixing module, and configured to receive and play the second sound mixing data.

2. The echo cancellation system of claim 1, wherein the sound signal generating device comprises an application and/or an audio decoder.

3. The echo cancellation system of claim 1, further comprising:
a reference module, connected to the first sound mixing module and echo cancellation module, respectively, configured to generate reference data corresponding to the first sound mixing data, and configured to input the first sound mixing data and the reference data to the echo cancellation module.

4. The echo cancellation system of claim 3, wherein the reference data is timestamp information corresponding to the first sound mixing data.

5. The echo cancellation system of claim 1, wherein the configuration of the loudspeaker comprises a 2.0 channel loudspeaker, a 5.1 channel loudspeaker, and a 7.1 channel loudspeaker.

6. The echo cancellation system of claim 1, wherein the playing module converts and amplifies the second sound mixing data through a driver, and output the converted and amplified data to a corresponding loudspeaker.

7. The echo cancellation system of claim 1, wherein the echo cancellation module comprises:
a sound acquisition unit for acquiring live audio data;
an echo cancellation unit, connected to the sound acquisition unit, configured to perform echo cancellation on the live audio data according to the first sound mixing data, and configured to sent the sound mixing data subjected to the echo cancellation to the voice assistant module.

8. An echo cancellation method of a multichannel sound mixing, comprising the steps of:
Step S1, receiving first audio data, output from a voice assistant module, and adapted to the configuration of a loudspeaker, and receiving second audio data, output from at least one sound signal generating device, and adapted to the configuration of the loudspeaker;
Step S2, copying the first audio data and the second audio data to obtain third audio data corresponding to the first audio data and fourth audio data corresponding to the second audio data;
Step S3, receiving the first audio data and the second audio data, and mixing and converting the first audio data and the second audio data to obtain two-channel first sound mixing data; and
receiving the third audio data and the fourth audio data, and mixing the third audio data and the fourth audio data to obtain second sound mixing data;
Step S4, performing echo cancellation according to the first sound mixing data; and
receiving and playing the second sound mixing data.

9. The echo cancellation method of claim 8, further comprising a step between Step S3 and Step S4: generating reference data corresponding to the first sound mixing data, and inputting the first sound mixing data and the reference data to the echo cancellation module.
